(19) United States
(12) Patent Application Publication
(10) Pub. No.: US 2006/0143596 A1
(43) Pub. Date: Jun. 29, 2006

(54) Program analyzing apparatus and testing apparatus, and analyzing method and program therefor

(76) Inventors: Hisashi Miyashita, Tokyo (JP); Hiroshi Horii, Yamato-Shi (JP); Yohsuke Ozawa, Fujisawa-Shi (JP); Mikio Takeuchi, Zama-Shi (JP)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/249,933

(22) Filed: Oct. 13, 2005

(30) Foreign Application Priority Data
Dec. 28, 2004 (JP) 378560

(51) Int. Cl. G06F 9/44

(52) U.S. Cl. 717/131

(57) ABSTRACT

The present invention makes it possible to perform a black-box test even on a system in which relationships between inputs and outputs cannot uniquely be determined, by enabling analysis of a cause-effect relation (dependency) between a state of an object and a state of another object in a program, thereby analyzing the cause-effect relation between the input and the output in the test. There are provided a cause-effect relation extracting section for extracting a cause-effect relation between a state of an object and a state of another object by executing the program under test step by step and obtaining in each step a history of changes made to fields of objects and information about fields that have caused the changes; and a testing section for performing a test based on an assertion of the test that is set between a given object to be examined and a causal object by analyzing a cause-effect relation to the given object to be evaluated on the basis of the cause-effect relations between objects extracted by the cause-effect extracting section to detect the causal object.

### FIELD OF THE INVENTION

The present invention relates to program analysis and in particular to a technique for extracting dependencies in a program written in an object-oriented program through dynamic analysis.

### BACKGROUND OF THE INVENTION

If the relation between inputs and outputs that can be known from the specifications of acomputer system is inherently indeterministic, a cause-effect relation between the inputs and outputs is often undetermined. For example, the order in which incoming inputs are processed in a multi-thread system can vary in an indeterministic manner depending on the state of execution of threads, and therefore an output cannot uniquely be determined from an input. This is a very common circumstance in programming models that use many threads in order to improve the level of parallel processing.

When a test is performed on such a system, the assertion between an input and an output cannot be described because no output that corresponds to the input can be determined. Here, the term test refers to in general an act that verifying the consistency between a model and an implementation. A black-box test is a method for testing a system by using only the specifications of the system as knowledge used in a model. An input is given to a system under test to obtain an output and verification is conducted as to whether the input and output meet the specifications. Each test is called a test case, which consist of a set of inputs and outputs.

A condition that associates between an input and the corresponding output is described in the assertion. Consider a system computing the largest integer (M) that does not exceed the n-th power root of a given real number (d) . If the system receives one real number and one integer (n) as inputs, and outputs one real number, then the assertion will be the following conditional expression:
((Mˆn<=d)&&(((M+1)ˆn)>d))

Methods that uses conventional techniques for performing a test in a case where system operations that meet specifications cannot deterministicallybedescribedmayincludeamethodinwhichamessage history is traced to verify the operations and a method in which cause-effect relations in data are traced during run time. If the method in which a message history is traced for verification is used, the input corresponding toanoutputmaybe identified fromthehistory of messages such as method calls between objects. A technique has been proposed that uses run-time tracing in run-time analysis of an object-oriented program to analyze cause-effect relations in parallel processing or cause-effect relations between operations. (Shreeram Salasrabudhe and Hector Munoz-Aliva, “Mining Cause-Effect Sequential Patterns from Action Traces”, [online], August 2003 (searched on Dec. 1, 2004) Internet URL: http://www.Lehigh.edu/˜sas4/html/ShereeramMunoz-ICML2003.PDF)

Another technique has been proposed that enables queries about relations between objects or about changes at a certain point of time during run time.

(Raimondas Lencevicious, Urs Holzle and Ambuj K. Singh, “Dynamic Query-Based Debugging of Object-Oriented Prgrams”, Journal of Automated Software Engineering, Volume 10, Number 1, pp. 39-74, Kluwer, January 2003)

If the method in which cause-effect relations in data are traced during run time is used, the input corresponding to an output may be identified from a history of access to physical memory data. An efficient differential debugging technique has been proposed that traces cause-effect relations in data to extract them as a graph and detects errors exclusively from the separated cause effect though it does not consider any about objects.

(Andreas Zeller, “Isolating Cause-Effect Chains from Computer Programs”, Proc. of ACM SIGSOFT 10th International symposium on the Foundations of Software Engineering (FSE-10), pp. 1-10, November 2002)

Another technique has been proposed for displaying a visible graph of the results of analysis of data dependencies traced.

(Thomas Zimmermann and Andreas Zeller, “Visualizing Memory Graphs”, Proc. of the Dagstuhl Seminar 01211, “Software Visualization”, Lecture Notes in Computer Science (LNCS) 2269, pp. 191-204, Springer-Verlag, May 2001)

As described above, the techniques that trace a message history or cause-effect relations in data during run time can be used to perform a test in a case where system operations that meet specifications cannot determinatively be described. However, none of these testing methods can be applied to black-box tests in which only the specifications are used as knowledge in a model.

To verify a system by tracing amessage history, what results internal messages actually produced on the system must be known beforehand. That is, the specifications of the internal messages must be known. This information cannot be obtained if a block-box test is to be performed. Moreover, in actual systems, some operation that are not saved inmessagehistories like exception ordirect manipulations of field can make changes to object. Therefore, simply tracing the message history does not provide sufficient cause-effect relations between inputs and outputs for testing.

The conventional technique disclosed in (Raimondas Lencevicious, Urs Holzle and Ambuj K. Singh, “Dynamic Query-Based Debugging of Object-Oriented Prgrams”, Journal of Automated Software Engineering, Volume 10, Number 1, pp. 39-74, Kluwer, January 2003) is a sort of interactive debugger that enables queries about relations between objects or about changes made to objects and, in theory, maybe capable of providing information required for cause-effect analysis in a certain period of time. However, the technique is not realistic because execution must be stopped on a-change-by-change basis to run a query about a change and log the change in order to record the history on the entire system.

If the technique that traces cause-effect relations in data during run time is applied to an object-oriented language such as Java® (Java® is a trademark of SunMicrosystems, Incorporated in the United States) that provides GC (Garbage Collection), the relation between an object, which is moved as a unit, and physical memory data must be externally provided. This is because, in a program in an object-oriented language that provides GC, addresses that holdvalues change during run time. Furthermore, if assertions can be examined in a test, it is essential to debugging to know why an assertion failed, in analysis after the test. However, cause-effect relation analysis based on data, the lack of object information makes it difficult to know the cause of a failure from a cause-effect relation obtained.

The conventional techniques disclosed in (3 and 4) do not include considerations of metadata that constitutes an object into a cause-effect relation and therefore lack information as to whether which data dependency corresponds to which object. Accordingly, these metadata cannot directly be connected with inputs in the cause-effect relation in an object-oriented environment unless an unrealistic method that specifies a particular memory address of the input is provided to the system under test.

Analysis of the cause-effect relation between fields using cause-effect relations in data requires metadata indicating how the data constitutes objects. That is, information as to which data corresponds to which filed of an object is require. Data-based cause-effect analysis that simply uses a conventional technique cannotprovide informationabout objectsunlessmetadataas described above is provided. It is conceivable that, without metadata, operations that give considerations to objects will be difficult to perform in interactive debugging.

Although it is not a technique for testing or debugging, a tainted flag uses such cause-effect analysis during runtime. This technique is used in a language such as Perl. A “tainted” state is dynamically stored in a variable and the flag propagates with propagation of information. Accordingly, the variable canbe checked to seewhether it may contain information that can endanger security. However, this technique can be used only for cause-effect analysis of a piece of information that indicates a “tainted” state and is not a generally applicable technique.

The present invention has been made in light of the technical problems described above. An object of the present invention is to enable analysis of a cause-effect relation (dependency) between a state of an object and a state of another object in a program written in an object-oriented language. With this, a cause-effect relation between an input and an output can be analyzed on the level of states of objects and a black-box test can be performed on a system in which the correspondence between an input and an output is not uniquely determined from the specifications of the system.

### BRIEF SUMMARY OF THE INVENTION

To achieve the object, the present invention is implemented as an apparatus that performs a test on a program of interest and has a configuration as described below. The apparatus includes a cause-effect relation extracting section that extracts a cause-effect relation between a state of an object and a state of another object by executing a program under test step by step and obtaining in each step a history of changes made to fields of objects and information about fields that have caused the changes; and testing section that performs a test based on an assertion of the test that is set between a given object to be examined and causative object by analyzing a cause-effect relation to the given object to be examined on the basis of the cause-effect relations between objects extracted by the cause-effect extracting section to detect the causal object.

More specifically, the cause-effect relation extracting section includes a stepwise executing section that executes a program under test step by step; and an abstract interpreting section that extracts in each step a cause-effect relation between a state of an object and a state of another object by obtaining a history of changes made to fields of objects and information about the fields of objects that have caused by changes on the basis of the result of the execution of the program under test by the stepwise executing section. The abstract interpreting section analyzes a portion in which a conditional branch based on the state of a given object affects the state of another object to obtain a cause-effect relation of an object governed by the conditional branch. Furthermore, the abstract interpreting section generates a based on the cause-effect relations between the objects, the directed graph being a graph in which each field of each object is represented by a node and an edge directed from a field that has caused a change to a changed field is provided.

The testing section can record the correspondence between each individual input in the test and an object actually generated from the input prior to the execution of the test, set an assertion between an input object that has caused an output object and the output object, and perform the test. The cause-effect relation extracting section can perform the execution of the program under test and the extraction of cause-effect relations between objects twice, store the extracted cause-effect relations between objects at the first performance, produce a copy of the objects on which the testing section specified as system under test inaddition to the cause-effect relations between the objects at the second performance.

The apparatus further includes a graph output section of generating and outputting a graph based on the cause-effect relations between objects extracted by the cause-effect relation extracting section, in which cause-effect relations to an object are indicated together by expressing a history of changes made to a field of the object during the lifetime of the object as a life line and by linking other objects that have caused the changes of the field to the given object by arrows to describe the cause-effect relations.

The present invention which achieves the objects is implemented as the following method for analyzing a program under test by a computer. The method includes a first step of, by the computer, executing the program under test step by step to obtain the result of the execution and saving the result of the execution a second step of, by the computer, reading the saved obtained execution result, obtaining in each step a history of changes made to fields of objects and information about fields of an objects that have caused the changes, extracting cause-effect relations between objects, and saving the cause-effect relations; and a third step of, by the computer, reading the saved cause-effect relations between the objects device and generating, a directed graph in which each field of each object is represented by a node and an edge is provided from a node that has caused a change to a changed node on the basis of the information including the cause-effect relations. The method may further include the steps of: by the computer, analyzing a cause-effect relation to a given object to be examined, on the basis of the cause-effect relation between the objects extracted at the second step to detect an causative object; and by the computer, performing a test on the basis of a test assertion set between the object to be examined and the causative object. Moreover, the method may further include the step of, by the computer, generating and outputting a graph based on the cause-effect relations extracted at the second step, in which cause-effect relations to a given object are indicated together by expressing a history of changes made to a field of the object during the life time of the object as a life line and by linking other objects that have caused the changes of the field to the object by arrows to describe the cause-effect relations. The step of outputting the graph in which the cause-effect relations to a given object are indicated together displays other objects and fields progressively that have affected the given object, starting from the given object. The method may display the graph if the program fails the test or if the program passes the test.

The present invention is implemented as a program that controls a computer to function as the apparatus describe above, or a program that causes a computer to perform a process equivalent to each step of the program analyzing method described above. The program can be delivered as a program stored in a magnetic disk, an optical disk, or a semiconductor memory, or other recording memory, or can be distributed over a network.

According to the present invention configured as described above, information is collected while executing a program under analysis step by step to obtain a history of changes made to fields of each object and information about causes of the changes, thereby obtaining a cause-effect relation between a state of an object and a state of another object. By considering the cause-effect relations, the cause-effect relations between inputs and outputs can be analyzed on a state-to-state basis of objects in a test of the program written in the object-oriented program. Because relations between inputs and outputs on a system in which the relations between inputs and outputs cannot uniquely be determined from its specifications can be known, a black-box test can be performed even on such a system.

### BRIEF DESCRIPTION OF THE DRAWINGS

FIG. 1 shows a functional configuration of a testing apparatus according to the present embodiment;

FIG. 2 schematically shows an exemplary hardware configuration of a computer suitable for implementing the testing apparatus shown in FIG. 1;

FIG. 3 is an exemplary code in a program under test in the present embodiment inwhicha cause-effect relation between states of objects is established by a conditional branch;

FIG. 4 shows an example of a dependency list generated according to the present embodiment;

FIG. 5 shows a correspondence between the instruction string in the dependency list shown in FIG. 4 and the state of a stack when a change actually made to a slot;

FIG. 6 shows an example of a dependency graph generated from the dependency list shown in FIG. 4;

FIG. 7 is a flowchart illustrating a process for generating a dependency graph from a dependence list according to the present embodiment;

FIG. 8 is a diagram illustrating an example of the generation of a graph indicating cause-effect relations between objects and showing a cause-effect relation of an Output object and an Average object according to the present embodiment;

FIG. 9 is a diagram illustrating an example of the generation of a graph indicating cause-effect relations between objects and showing cause-effect relations of the Average object to Result objects according to the present embodiment;

FIG. 10 is a diagram illustrating an example of the generation of a graph indicating cause-effect relations between objects and showing relations between the Result objects and a ResultSet object according to the present embodiment;

FIG. 11 is a diagram illustrating an example of the generation of a graph indicating cause-effect relations between objects and showing cause-effect relations of a Request object to the Average object which are weak-causalities according to the present embodiment;

FIG. 12 shows a state in which the display graph shown in FIG. 11 is displayed along with the source cord of the program under test; and

FIG. 13 is a flowchart illustrating a process performed by a graph output section for generating a display graph according to the present embodiment.

### DETAILED DESCRIPTION OF THE INVENTION

The present invention traces operations of systems during execution of a program to analyze cause-effect relations of changes of objects. In particular, a directed graph indicating a cause-effect relation as to which object's state generated or changed an object's state (the directed graph is hereinafter referred to as the dependency graph) is generated. Then, the system (program) of interest is tested by analyzing the dependency graph to obtain the input used for an output and examining a condition between the input and the output. In this way, a black-box test can be conducted on the system (program) without altering the system (program). Moreover, an edited display version of the dependency graph is presented to a user to allow the user to efficiently analyze as to which object's state generates the state of an object of interest (for example an incorrect object) or the state of an object that appears in an assertion, and to debug the system.

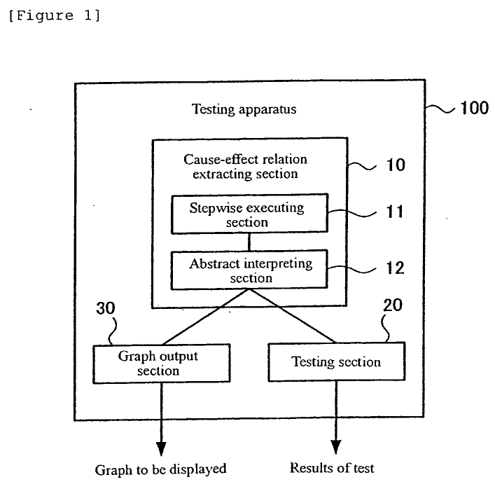

FIG. 1 shows a functional configuration of a testing apparatus of the present embodiment. The testing apparatus 100 shown in FIG. 1 includes a cause-effect relation extracting section 10 which extracts cause-effect relations between a state of an object and a state of another object in a program to be tested (hereinafter referred to as a program under test), a testing section 20 which performs a test by using the cause-effect relations extracted by the cause-effect relation extracting section 10, and a graph output section 30 which outputs the cause-effect relations extracted by the cause-effect relation extracting section 10 as a display. The testing apparatus 100 is implemented by a personal computer, workstation, or other computer system.

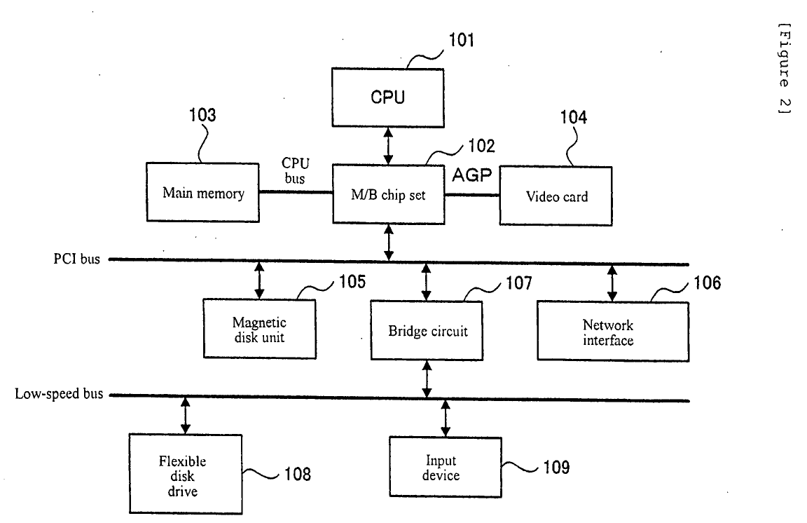

FIG. 2 schematically shows an exemplary hardware configuration of a computer suitable for implementing the testing apparatus shown 100 in FIG. 1. The computer shown in FIG. 2 includes a CPU (Central Processing Unit) 101, a main memory 103 which is connected to the CPU 101 through a MB (Motherboard) chipset 102 and a CPU bus, a video card 104 which is also connected to the CPU 101 through the MB chipset 102 and an AGP (Accelerated Graphics Port), a magnetic disk unit (HDD) 105 and a network interface 106 which are connected to the MB chipset 102 through a PCI (Peripheral Component Interconnect) bus, and a flexible disk drive 108 and input devices 109 such as a keyboard and a mouse which are connected to the MB chipset 102 through a bridge circuit 107, a low-speed bus such as an ISA (Industry Standard Architecture) bus, and the PCI bus.

It should be noted that the hardware configuration of the computer implementing the present embodiment shown in FIG. 2 is illustrative only and various other configurations to which the present embodiment can be applied may be used. For example, instead of adding the video card 104, a video memory by itself may be used and image data may be processed on the CPU 101. Also, external storage devices such as a CD-R (Compact Disc Recordable) or DVD-RAM (digital Versatile Disc Random Access Memory) drive may be attached through an interface such as an ATA (AT Attachment) or a SCSI (Small computer System Interface).

The cause-effect relation extracting section 10 of the testing apparatus 100 shown in FIG. 1 may be implemented by the CPU 101 controlled by the program shown in FIG. 2, the main memory 103, and a storage device such as the magnetic disk unit 105. The cause-effect relation extracting section 10 identifies which object's state changed or generated a particular object's state (field) and describes a cause-effect relation in a program under test. (It should be noted that an array is also regarded as an object and each element of an array or the length of an array is also regarded as a field.) That is, in addition to data dependencies which are obtained by tracing, dependencies of states of objects are analyzed and a dependency graph is generated as means for describing cause-effect relations.

The cause-effect relation extracting section 10 includes a stepwise executing section 11 and an abstract interpreting section 12 as shown in FIG. 1. The stepwise executing section 11 executes a program under test step by step to obtain events and stores the events in a storage device such as a cache memory of the CPU 101 shown in FIG. 2. The functions of the stepwise executing section 11 canbeprovided by an existing API (Application Program Interface) for debugging (hereinafter referred to as the debugging API). The abstract interpreting section 12 traces data dependencies. The abstract interpreting section 12 reads and interprets events obtained by the stepwise executing section 11 and held in the storage device, thereby indicating cause-effect relations between objects with attention focused on instructions which are the minimum unit of data dependencies. With this arrangement, independence of test cases from an implementation of a system under test can be retained.

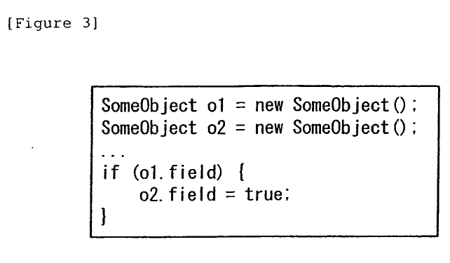

A cause-effect relation between the state of an object and the state of another object may be established by a conditional branch. An example of such a code is shown in FIG. 3. It is considered that all state changes affected by the branch caused by ol.field have a cause-effect relation with ol.field in this code. In other words, it is considered that o2 is affected by o1. The causality of a cause-effect relation generated from a control dependency in this way is referred to as a “weak-causality”. Such a causality can be introduced in a cause-effect relation by performing control flow analysis (static analysis) of methods containing branch instructions. It may be appears that there is no use treating weak-causality specially since a control dependency is interchangeable with a data dependency. However, in procedural languages such as Java®, control dependencies are usually used for purposes different from those of data dependencies. In addition, a change in a control flow in those languages affects a wide range. Accordingly, if weak-causalities were displayed without change, an enormous number of relations would be displayed in many cases. Therefore, it is useful in program analysis to separate weak-causalities from ordinary causalities.

How the cause-effect extracting section 10 generates a dependency graph will be detailed below. The concept of a slot will be defined first. The concept of a slot implies an area (storage location) represented by a local variable or a stack variable (which are thread-context-dependent), or fields of an object (class field and instance field). Using slots, a dependency can be defined as follows:
(slot 1, . . . , slot n)→slot

The left side of this definition indicates the depended-on slots and the right side represents the depending slot. That is, the expression consists of n depended-on slots and one depending slot. This means that values are set from the n slots on the left side into the slot on the right side. An object can be identified by a unique object ID provided by a debugging API or a unique ID assigned by the abstract interpreting section 12 itself in generating the object.

In the cause-effect relation extracting section 10, the stepwise executing section 11 executes a program under test stepwise and the abstract interpreting section 12 receives events from the stepwise executing section 11 to obtain information as to which instruction in the program under test was executed. Then, the abstract interpreting section 12 traces depended-on slots of stack variables according to the information. It also traces depended-on slots of local variables and fields of objects. Once depended-on slots of a particular slot have been set in an another slots, a cause-effect relation is established between the two slots.

The abstract interpreting section 12 obtains information about cause-effect relations between slots in this way, generates a list of history of changes of slots (dependency list), and stores the list in the main memory 103 or a cache memory of the CPU 101 shown in FIG. 2, for example. In the dependency list, dependencies are listed in such a way that the order in which assignments as described above have actually occurred is retained. Furthermore, an instruction string corresponding to the listed items of the program under test is registered in the dependency list in association with cause-effect relations between slots.

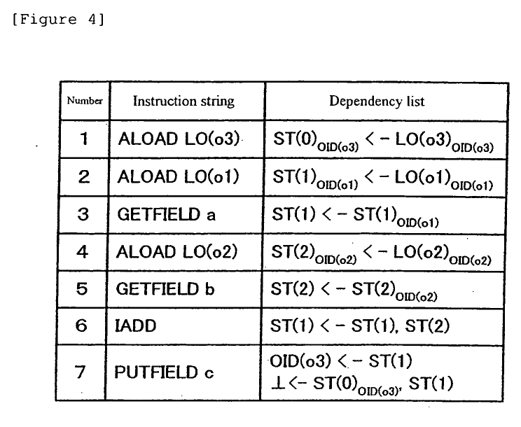

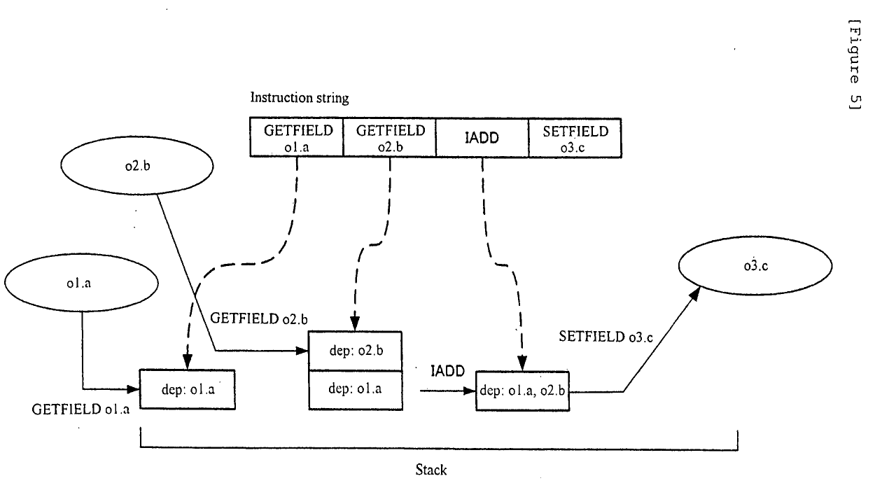

FIG. 4 shows an example of a dependency list generated as described above. FIG. 5 shows an instruction string in the dependency list shown in FIG. 4 and a stack in a state in which a change is actually made to slots. The instruction string in the example shown in FIG. 4 is a Java® byte code. Instructions that load object to stacks (ALOAD LO(o3), ALOAD LO(o1), and ALOAD LO(o2)) arenot shown in FIG. 5.

Referring to FIGS. 4 and 5, a cause-effect relation can be obtained in which fields ol.a and o2.b are the cause and filed o3.c is the effect. As described above, it is useful to separate a weak-causality from normal causalities because since a weak-causality affects a considerably wide range. Therefore, additional data is attached to weak-causalities to allow them to be distinguished from ordinary when they are registered in a dependency list as shown in FIG. 4 or a dependency graph, which will be described below, is generated. (If a dependency graph is edited for display and output, representations of cause-effect relations can be modified so that weak-causalities can be visually identified.)

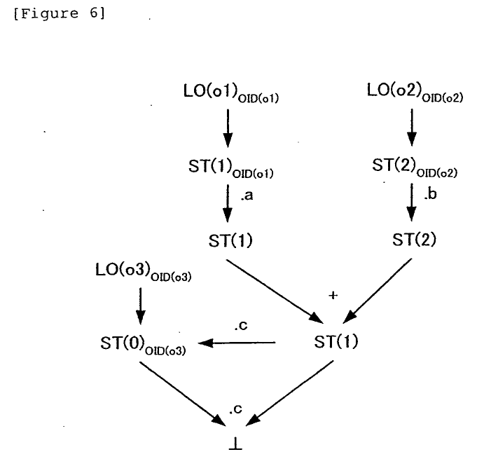

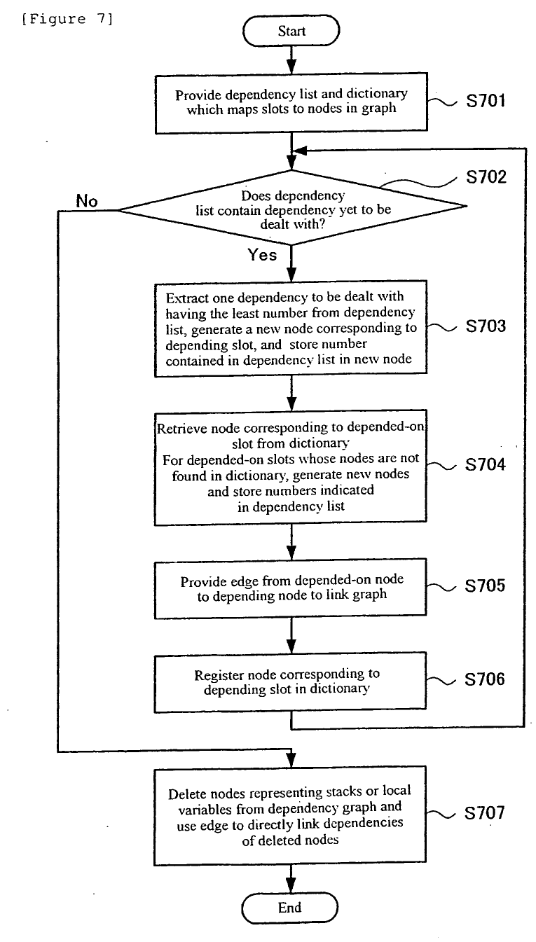

The abstract interpreting section 12 further generates a graph (dependency graph) representing dependencies between slots. FIG. 6 shows a dependency graph generated from the dependency list shown in FIG. 4. FIG. 7 is a flowchart illustrating a process for generating the dependency graph from the dependency list. Referring to FIG. 7, the abstract interpreting section 12 first provides a dictionary (such as a hash table) that maps slots to nodes in a graph, together with a dependency list as shown in FIG. 4 (step 701). Then, the abstract interpreting section 12 extracts one dependency to be dealt with having the least number from the dependency list and generates a new node corresponding to the depending slot. The number of the dependency in the dependency list is stored in the new node (steps 702 and 703).

Then, the abstract interpreting section 12 extracts nodes corresponding to the depended-on slots from the dictionary. If the abstract interpreting section 12 cannot find a node corresponding to a depended-on slot, it creates a new node for that depended-on slot. This situation occur in the case where only certain classes are traced or only a recent finite number of pieces of trace information are held for the purpose of reduction of memory usage or execution time. The label of that depended-on slot in the dependency list is stored in the new node (step 704).

The abstract interpreting section 12 then provides edges directed from the depended-on nodes to the depending node to link them (step 705). Then, it registers the node corresponding to the depending slot in the dictionary (step 706).

Then, the abstract interpreting section 12 returns to step 702, searches the dependency list for additional dependencies to be dealt with. If there are additional dependencies, the abstract interpreting section 12 repeats the operations from step 703 to step 706. After processing all dependencies contained in the dependency list, the abstract interpreting section 12 removes the nodes representing stack variables or local variables from the dependency graph generated through the process. Then, dependencies originally linked to those nodes are replaced with a direct edge, and then the process end (step 707).

Instead of storing the history of changes made to slots, a copy of objects or fields may be made and stored to provide information required for generating a dependency graph. By storing a history of changes to slots or a copy of objects (or fields), a state of the objects at any time point can be reproduced. The states of objects at all time points may not always be required. In some cases, checking the state of objects during debugging or testing may be enough. For example, the state of an immutable object does not changes its state and therefore checking the last state of the object is enough. However, objects that are no longer referred to are usually deleted by garbage collection (GC) and therefore even objects in the last state may not be able to be obtained during testing or debugging described later. The state of such objects that exist only temporarily during execution can be known at any time by recording them in an appropriate order or by protecting objects of interest from GC by using the ObjectReference.disableCollection( ) function of a debugging API (for example JDI (Java® Debugger Interface), which is a Java® debugging API). Furthermore, saving a copy of objects relating to a change when recording a slot change history enables the state of the objects to be known in detail during debugging. Moreover, objects that exist only temporarily can made available during testing or debugging by protecting the objects from GC as describe above even if a change history is not recorded or the objects are not copied.

Storing the states of all temporary objects of history of all changes to slots requires a large amount of memory, whichmaybe impractical. To solve the problem, cause-effect relations between states of objects may be extracted twice (the program under test is traced twice) . In that case, only the IDs of objects and cause-effect relations are recorded during the first trace without storing the states of temporary objects or a history of changes to slots. The record of the cause-effect relations obtained during the first trace is used to solve the inverse problem for an objects of interest (upstream search is performed in a cause-effect relation graph of the objects that affect the state of a selected object, starting from the selected object). An object of interest may be an output inatestoranobject tobe debugged, forexample. During the second trace, the states of only the temporary objects or the history of changes to only the slots that were found by the search is stored. The execution pattern of the second trace must be the same as that of the first trace. Therefore, it is preferable that an execution environment such as deJaVu or ConTest in which a program can be re-executed be used.

A method for tracing data dependencies in the exemplary implementation will described below with respect to an example in which a program under test written in Java is analyzed and JDI is used as a debugging API that provides functions of the stepwise executing section. In procedural object-oriented languages, including Java®, that have an exception handling mechanism, data dependencies are traced from an instruction described below.
1. Intra-frame data dependency
1.1. Definition and use of stack variable (for stack machine only) (See paragraph [0047].)
1.2. Definition and use of local variable (See paragraph [0047].)
2. Inter-frame data dependency
2.1 Actual parameter for method call (See paragraph [0048].)
2.2 Returned value from method (See paragraph [0049].)
2.3 Exception occurrence and catch (See paragraph [0050].)
3. Intra-thread (object) data dependency
3.1 Definition and use of field variable (See paragraph [0051].)

The Java® Virtual Machine (VM) instruction set is defined in the Java® Virtual Machine Specification. The Java® Virtual Machine specification defines the meaning of the operation, increase or decrease in the level of operand stack, and the side effect of each instruction. However, there are ambiguities in the types of fields to be defined or used and in the types of parameters and a return value for method calls. Their actual types are determined only by referring to corresponding entries in the ConstantPool of the class that implement the methods. The Java® virtual machine has an architecture in which one slot consist of 32 bits and 64-bit long and double type operands use two contiguous slots. Accordingly, if the type of an operand is not known for the definition and the use of a stack variable, stack-level adjustments cannot properly be made.

The present exemplary implementation uses Java® Debugger Interface (JDI) as the debugging API. The JDI is a Java® API which is used by a debugger to control the execution of a program in a Java® virtual machine or to access an internal state and provides basic functions for implementing the debugger such as a stepwise execution and breakpoints. In the present exemplary implementation, the JDI is used to stepwise execute a system under test and an instruction string obtained is traced by focusing only on data dependencies. To trace data dependencies of stack variables, the size of operand must be known in order to make stack-level adjustments. However, the JDI does not provide means for accessing ConstantPools of classes. For simplicity, a specialized event that provide more information may be used in addition to step events for field definitions and uses, method calls, and returns, which contain ambiguities. In practice, the ambiguity of the type of stack variables can be eliminated by performing static analysis of methods in most cases because Java®-based systems ensure the uniqueness of the type of a stack variable at any reachable position in a method.

Event tracing by the abstract interpreting section 12 is performed on the entire system and on each of the instructions that trace the data dependencies given above (intra-frame, inter-frame, intra-thread (object) data dependencies), as described below.

On the Entire System

The abstract interpreting section 12 sets a ClassPrepareEventRequest for all classes (filter settable) in the system under test during the startup of the system under test. Then, the abstract interpreting section 12 sets ExceptionEventRequest, MethodEntryEventRequest, and MethodExitEventRequest for all threads (filter settable) and all classes (filter settable). It also sets a ThreadStartEventRequest for all threads (filter settable) in the system under test.

When a class is loaded, the abstract interpreting section 12 sets ModificationWatchpointEventRequest and AccessWatchpointEventRequest for all field (filter settable) of the class in processing ClassPrepareEvent.

When a thread is started, the abstract interpreting section 12 creates a corresponding thread for an abstract interpreting machine in handling the ThreadsStartEvent. It also sets a StepEventRequest for the methods of all classes (filter settable) executed by the thread.

Inter-Frame Data Dependency

The abstract interpreting section 12 records a sum set of data dependencies of multiple variables that are referenced by an instruction as data dependencies of the variables defined by the instruction, in both stack variable definition and use and local variable definition and use, in corresponding slots.

Intra-Frame Data Dependency

When MethodEntryEvent is processed, the abstract interpreting section l2 creates a new frame in a corresponding thread of the abstract interpreting machine for actual parameters in the method call. Then it copies the data dependency of local variables corresponding to the actual parameters of the method from the stack top of the previous frame.

WhenMethodExitEvent is processed, the abstract interpreting section 12 records in the current frame the data dependency at the stack top as the data dependency of the return value from the method. When StepEvent of the next instruction in the same threads is processed, the abstract interpreting section 12 pops one frame, pops the as many entries as the number of the actual parameters of the returned method from the stack, and pushes the data dependency of the returned value of the returned method as the data dependency at the stack top.

For exception occurrence and catch, the abstract interpreting section 12 records the data dependency at the stack top in the current frame as the data dependency of the exception object. When StepEvent of the next instruction in the same thread is processed, the abstract interpreting section 12 pops the same number of frames as the difference between the frame in which the exception has occurred and the current frame, pops all entries in the stack, and pushes the data dependency of the exception object as the data dependency at the stack top.

Intra-Thread (Object) Data Dependency

For field variable definition and use, the abstract interpreting section 12 pops the data dependency at the stack top and sets it as the data dependency of the field variable of the object when ModificationWatchPointEvent is processed. When AccessWatchpointEvent is processed, the abstract interpreting section 12 pushes the data dependency of the field variable of the object as the data dependency at the stack top.

The implementation described above is one example of the implementation for a program under test written in Java ®. Inpractice, various other implementations are possible according to the operating environment of a system in which the present embodiment is implemented and a language used and the like (Java® or other object-oriented language).

In this way, a dependency graph is generated in which case-effect relations between states of objects are reflected. The dependency graph generated is stored in a storage device such as the main memory 103 shown in FIG. 2 and used by the testing section 20 and the graph output section 30. Another implementation method for obtaining information about objects during execution may be used in which a code that causes an event to occur is added to a system under test. In yet another implementation in which a system under test is executed on a virtual machine, a modification may be made to the virtual machine so that data dependencies are traced concurrently with the execution of an instruction on the virtual machine. However, the embodiment have the following advantages:
(1) the behavior of the system under test is not changed because the system is not changed;
(2) systems that can be tested are not limited to those executed on a virtual machine because a general-purpose debugging API is used; and
(3) the embodiment is not dependent on the implementation of a virtual machine because no modification is made to the virtual machine.

Data dependency between objects that are not involved in the computation of outputs are not necessarily required for testing and debugging. Therefore the instructions to those objects can be excluded from stepwise execution. This can prevent the stepwise executing section 11 from generating unnecessary events and eliminate the cost for the abstract interpreting section 12 to received and ignore the events. Also, threads in a system under test that are known not to affect the execution of the system under test can also be eliminated from stepwise execution. Examples of such threads include system threads such as a finalizer and a reference handler, and threads of a debugging API itself in a program executed on a Java® virtual machine.

According to the present embodiment, a dependency graph obtained as described above can be used to analyze cause-effect relations between inputs and outputs during testing a program under test or investigating the cause of failure during debugging. The testing section 20 may be implemented by the CPU 101 and the main memory 103 shown in FIG. 2, for example, under the control of a program. The testing section 20 performs a black-box test on a program under test. In particular, the testing section 20 provides an input to a system implemented by the program under test, obtains an output, and examine whether the input and output meet specifications, by using an assertion. The dependency graph generated by the cause-effect-relation extracting section 10 can be used in the analysis of the cause-effect relation between an input and output. In particular, the cause-effect relation of an object to be examined is analyzed on the basis of the dependency graph to identify its causative object. Then, an assertion can be set between the two objects to perform a test.

During testing, an input object can be changed or deleted. To prevent this, a method of tracing temporary objects as described earlier can be used. However, if performing a test is the sole purpose, a more efficient method can be used. That is, before performing the test, correspondence between an input in the test and an object generated by the input may be established. To examine the assertion, an input object (which may no longer live or may be changed) that corresponds an output object is obtained through cause-effect relation analysis using the dependency graph. Then an input in the test is obtained from the input object and the assertion between the input and output can be examined.

The graph output section 30 may be implemented by the CPU 101, the main memory 103, and the video card 104 shown in FIG. 2, for example, under the control of a program. The graph output section 30 edits a dependency graph generated by the cause-effect relation extracting section 10 to generate a graph indicating cause-effect relations between objects (hereinafter referred to as a display graph) and outputs the graph on a display device. Specifically, in the display graph, a history of changes made to slots during the lifetime of an object is represented by a life line and an arrow is drawn to the object from an object that causes a change to the slot, thereby describing the cause-effect relation (field information is written near the arrow). In this way, cause-effect relations to the same object can be indicated together and a user can readily refer to and analyze the cause-effect relations. The starting point of the life line may be the point at which a cause-effect relation with another object was first observed and the end point may be a point at which it was last observed. An object specified by a user or an object to be examined in the test can be used as the string point and objects or fields that affected the object can be indicated progressively to further facilitate the cause-effect analysis.

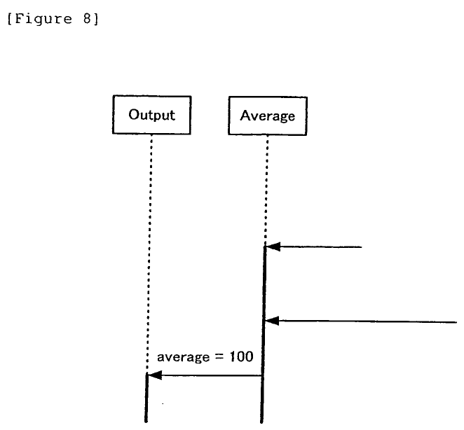

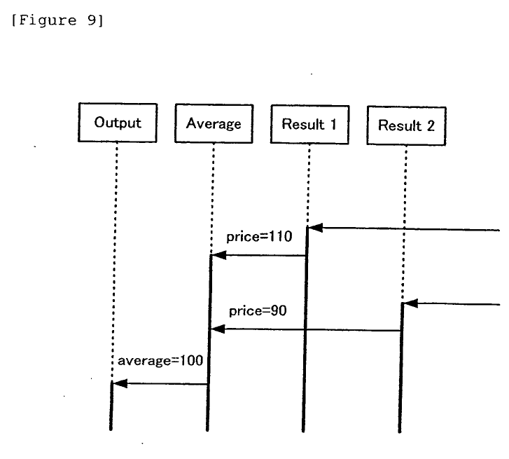

FIGS. 8 to 11 show exemplary display graphs. The graphs in the examples shown in FIGS. 8 to 11 are graphical representations resembling a UML sequence diagram. In the examples in FIGS. 8 to 11, an output from a test performed by the testing section 20 is examined to see whether it is correct or not. First, searching for a cause-effect relation, starting at the Output object, shows that there is a relation in which an Average object outputted an average to the Output object (See FIG. 8). Then, searching a cause-effect relation, starting at the Average object, shows relations of the Average object to two Result objects. The average object obtains price fields from the two Result objects (See FIG. 9).

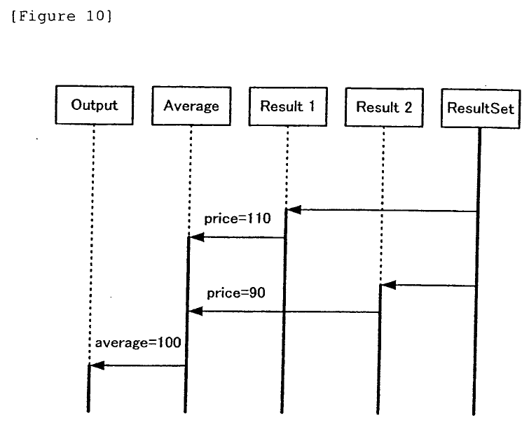

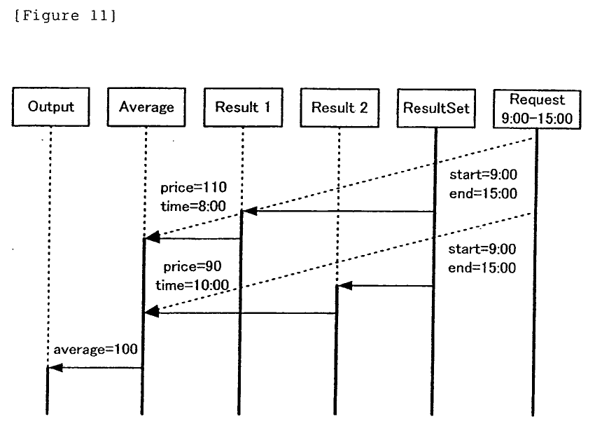

Searching a cause-relation, starting from the Result objects, shows that the two Result objects were copied from a ResultSet object (See FIG. 10). When the graph is developed to display weak-causalities of the Average object, cause-effect relations produced by a check as to whether the Result objects should be used for the calculation of the average are displayed from conditional branches at which the time fields of the Result objects are compared with the start and end fields of a Request object (See FIG. 11). It is preferable that weak-causalities be displayed in a readily visible manner, such as by a dotted line, in distinction from other cause-effect relations, because a weak-causality in general affects a wider range.

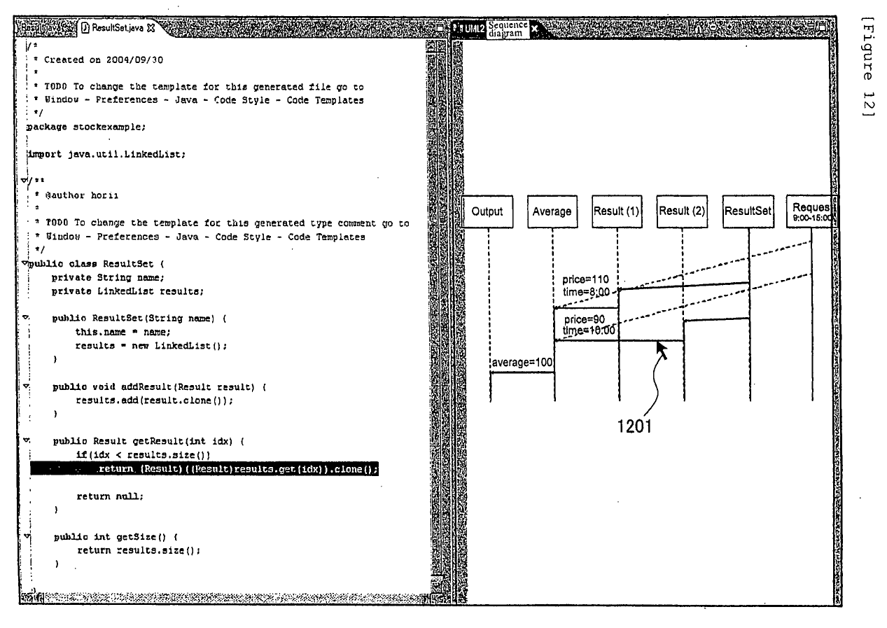

FIG. 12 shows a state in which the display graph shown in FIG. 11 are displayed along with the source code of the program under test. The line highlighted in reverse video in the source code in FIG. 12 is the code corresponding to the line (cause-effect relation) pointed by the pointer (arrow) 1201 in the display graph. When a particular cause-effect relation is selected in the display graph, the actual code that provided the cause-effect relation is indicated. Because a dependency (a change of slot) and the corresponding code (instruction) has been known at the point of time when the cause-effect relation extracting section 10 has generated the dependency list for generating the dependency graph, the graph output section 30 can display the correspondence as shown in FIG. 12 by reading the information from the dependency graph.

If a program under test contains a loop, at first the loop section can be compactly displayed as a mark indicating that there is a loop in that section, in order to prevent the display graph from being complicated. When an action such as a mouse click is performed on the loop section, the loop section can be developed and displayed.

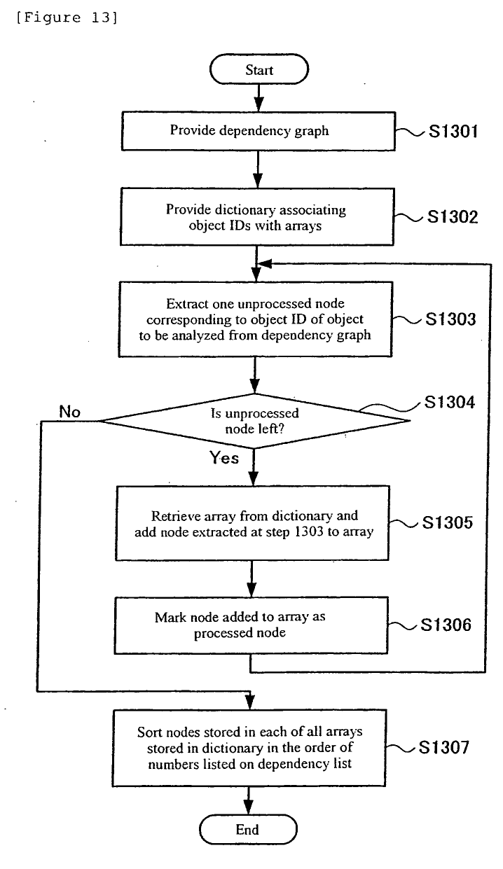

FIG. 13 is a flowchart illustrating a process performed by the graph output section 30 for generating a display graph. Referring to FIG. 13, the graph output section 30 first reads and provides a dependency graph generated by the cause-effect relation extracting section 10 and stored in a storage device such as the main memory 103 (step 1301). It also provides a dictionary (such as a hash table) that associates object IDs with arrays (step 1302).

Then the graph output section 30 extracts an unprocessed node associated with the object ID of an object to be analyzed from the dependency graph (step 1303). If there is an unprocessed node, the graph output section 30 refers to the dictionary to retrieve an array with the object ID and adds the node extracted at step 1303 to the retrieved array (steps 1304 and 1305). The node added to the array is marked as a processed node (step 1306).

Operation from step 1303 to step 1306 is repeated until no unprocessed node associated with the object ID of an object to be analyzed is left (step 1304: NO), then the graph output section 30 sorts the nodes stored in each of the arrays stored in the dictionary, in the order of the numbers contained in the dependency list (step 1307).

Thus, a display graph in which the cause-effect relations of the same objects are displayed together is generated. The graph output section 30 generates the image data of the display graph through the use of the video card 104 and displays it on the display device. The graph output section 30 may generate and display the display graph if the program fails the test performed by the testing section 20 or if the program passes the test.

It is important to note that while aspects of the present invention have been described in the context of a fully functioning computer system, those of ordinary skill in the art will appreciate that processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such-as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

Description of Symbols

10 . . . Cause-effect relation extracting section
11 . . . Stepwise executing section
12 . . . Abstract interpreting section
20 . . . Testing section
30 . . . Graph output section
100 . . . Testing apparatus
101 . . . CPU (Central Processing Unit)
103 . . . Main memory
104 . . . Video card
105 . . . Magnetic disk unit (HDD)

What is claimed is:

1. A program analyzing apparatus for analyzing a program under test written in an object-oriented language, comprising:
a stepwise executing section of executing the program under test step by step; and
an abstract interpreting section of extracting in each step a cause-effect relation between a state of an object and a state of another object by obtaining a history of changes made to fields of objects and information about the fields of objects that have caused the changes on the basis of the result of the execution of the program under test by the stepwise executing section.

2. The program analyzing apparatus according to claim 1, wherein a function of the stepwise executing section is implemented by executing an API (Application Program Interface) for debugging the program under test.

3. The program analyzing apparatus according to claim 1, wherein the abstract interpreting section analyzes a portion in which a conditional branch based on the state of a given object affects the state of another object to obtain a cause-effect relation of an object governed by the conditional branch.

4. The program analyzing apparatus according to claim 1, wherein the abstract interpreting section generates a directed graph based on the cause-effect relations between the objects, the directed graph being a graph in which each field of each object is represented by a node and an edge directed from a field that has caused a change to a changed field is provided.

5. The program analyzing apparatus according to claim 1, wherein the abstract interpreting section produces a copy of at least some of the objects the history of changes of the field of which has been obtained and the objects that have caused the changes, and stores the copy in a predetermined storage device.

6. The program analyzing apparatus according to claim 1, further comprising a graph output section of generating and outputting a graph based on the cause-effect relations extracted by the abstractinterpretingsection, inwhichcause-effectrelations to a given object are indicated together by expressing a history of changes made to a field of the object during the lifetime of the object as a life line and by linking other objects that have caused the changes of the field to the object by arrows to describe the cause-effect relations.

7. A testing apparatus for testing a program under test, comprising:
a cause-effect relation extracting section of extracting a cause-effect relation between a state of an object and a state of another object by executing the program under test step by step and obtaining in each step a history of changes made to fields of objects and information about fields that have caused the changes; and
a testing section of performing a test based on an assertion of the test that is set between a given object to be examined and a causal object by analyzing a cause-effect relation to the given object to be evaluated on the basis of the cause-effect relations between objects extracted by the cause-effect extracting section to detect the causal object.

8. The testing apparatus according to claim 7, wherein the testing section records the correspondence between each individual input in the test and an object actually generated from the input prior to the execution of the test, sets an assertion between an input object that has caused an output object and the output object, and performs the test.

9. The testing apparatus according to claim 7, wherein the cause-effect extracting section performs the execution of the program under test and the extraction of cause-effect relations between objects twice, stores the extracted cause-effect relations between objects in a storage device at the first performance, produces a copy of the objects on which the testing section has performed the test, and stores the copy in a storage device in addition to the cause-effect relations between the objects at the second performance.

10. The testing apparatus according to claim 7, further comprising a graph output section of generating and outputting a graph based on the cause-effect relations extracted by the abstract interpreting section, in which cause-effect relations to an object are indicated together by expressing a history of changes made to a field of the object during the lifetime of the object as a life line and by linking other objects that have caused the changes of the field to the given object by arrows to describe the cause-effect relations.

11. A program analyzing method for analyzing by a computer a program under test, comprising:
a first step of, by the computer, executing the program under test step by step to obtain the result of the execution and storing the result of the execution in a storage device;
a second step of, by the computer, reading the obtained execution result from the storage device, obtaining in each step a history of changes made to fields of objects and information about fields of an objects that have caused the changes, extracting cause-effect relations between objects, and storing the cause-effect relations in a storage device; and
a third step of, by the computer, reading the cause-effect relations between the objects from the storage device and generating, on the basis of the information including the cause-effect relations, a directed graph in which each field of each object is represented by a node and an edge is created from a node that has caused a change to a node changed.

12. The program analyzing method according to claim 11, further comprising the step of analyzing a portion in which a conditional branch based on the state of a given object affects the state of another object and obtaining a cause-effect relation of an object governed by the conditional branch;
wherein the third step generates the directed graph including the cause-effect relation based on the conditional branch.

13. The program analyzing method according to claim 11, further comprising the steps of:
by the computer, analyzing a cause-effect relation to a given object to be examined, on the basis of the cause-effect relation between the objects extracted at the second step to detect an causative object; and
by the computer, performing a test on the basis of a test assertion set between the object to be examined and the causative object.

14. The program analyzing method according to claim 11, further comprising the step of, by the computer, generating and outputting a graph based on the cause-effect relations extracted at the second step, in which cause-effect relations to a given object are indicated together by expressing a history of changes made to a field of the object during the lifetime of the object as a life line and by linking other objects that have caused the changes of the field to the object by arrows to describe the cause-effect relations.

15. The program according to claim 14, wherein the step of outputting the graph in which the cause-effect relations to a given object are indicated together displays other objects and fields progressively that have affected the given object, starting from the given object.

16. The program analyzing method according to claim 11, further comprising the steps of:
by the computer, analyzing a cause-effect relation to a given object tobe examined, on the basis of the cause-effect relation between the objects extracted at the second step to detect an causative object;
by the computer, performing a test on the basis of a test assertion set between the object to be examined and the causative object; and
generating and outputting a graph in which cause-effect relations to an object tested are indicated together, on the basis of the directed graph generated at the third step if the program fails or passes the test.
